(19) United States
(12) Patent Application Publication
(10) Pub. No.: US 2012/0100273 A1
(43) Pub. Date: Apr. 26, 2012

(54) PROCESS FOR PROCESSING ANIMAL PROTEIN PRODUCT INTO COOKED, SLICED FORM

(75) Inventor: Jean-Pierre GUILLAUD, Alexandria, VA (US)

(73) Assignee: Cuisine Solutions, Inc., Alexandria, VA (US)

(21) Appl. No.: 12/911,881

(22) Filed: Oct. 26, 2010

(51) Int. Cl. A23B 4/005; A23B 4/10; B65B 25/06

(52) U.S. Cl. 426/393; 426/412

(57) ABSTRACT

A process for processing animal protein product involves cutting a substantially raw piece of the product into slices, vacuum sealing the sliced raw product in a pouch with the slices stacked tightly together, cooking the vacuum sealed product to at least its pasteurization temperature while vacuum sealed within the pouch, and refrigerating or freezing the pasteurized product still sealed in the pouch.

### BACKGROUND

This invention relates to a process for processing animal protein product into cooked, sliced form.

### RELATED ART

Processes are known, in which a cooked animal protein product is shipped in the form of individual slices. The flow chart of FIG. 1 illustrates a prior art process in which a raw piece 10 of the product is cooked in an oven 12 in step S100. Then, the cooked piece of product is cut into thin, i.e., 1.0-5.0 mm thick, slices 14 in step S110. The sliced product is then heated in an oven 16, not under vacuum, to a pasteurization temperature in step S120, in an effort to to destroy bacteria that may have entered the product during the slicing step. The sliced, pasteurized product is then placed in a package 18 and refrigerated for shipment in step S130.

It would be desirable to provide packages of sliced animal protein product in a more economical manner while also providing a better tasting, more nutritious, less shrunken, and more fully pasteurized product.

### SUMMARY

Disclosed herein is a process for processing animal protein product comprising the steps of:
A. slicing the product into slices while in a raw state;
B. vacuum sealing the sliced raw product within a pouch with the slices stacked tightly together;
C. cooking the vacuum sealed product to at least its pasteurization temperature while vacuum sealed in the pouch; and
D. refrigerating or freezing the cooked product in the pouch.

Also disclosed herein is a process for processing meat, poultry or game product comprising the steps of:
A. brazing or searing the product on at least one outside surface;
B. slicing the brazed or seared product into slices of 1.0-5.0 mm thickness while the product is in a substantially raw state;
C. vacuum sealing the sliced raw product within a pouch with the slices stacked tightly together;
D. cooking the vacuum sealed product to at least its pasteurization temperature while vacuum sealed in the pouch; and
E. refrigerating or freezing the cooked product still in the pouch.

### BRIEF DESCRIPTION OF THE DRAWING FIGURES

FIG. 1 is a flow chart describing a conventional process for processing animal protein product.

FIG. 2 is a flow chart describing a new process for processing and packaging animal protein product.

### DETAILED DESCRIPTION OF A PREFERRED EMBODIMENT

In the process described below, a piece of animal protein product is sliced while in a raw state, and only one cooking step is performed, in contrast to prior art processes in which the product is sliced only after being cooked, and then requires subsequent pasteurization. Moreover, a sous-vide cooking process is employed to cook the sliced raw product in a vacuum sealed pouch.

The flow chart of FIG. 2 depicts steps involved in the process. In a first, optional step S200, a piece of raw product 20 is brazed or seared on one or more of its outside surfaces. The optional brazing or searing step is simply for providing some texture such as grill marks. A second optional step, i.e., step S210, involves chilling the piece of product, e.g., to a temperature below room temperature, preferably to 32-34° F. In some cases, such as with smoked meats, it has been found that the slicing step discussed below is made easier if the product has been chilled.

The piece of raw product is cut into thin slices 22, e.g. 1.0-5.0 mm thick in a conventional slicing machine in step S220. As discussed above, the slicing step can occur with the product at room temperature or chilled.

The sliced piece of raw product is then vacuum sealed in a pouch 24 in step S230 and is then cooked in step S240, while vacuum sealed in the pouch, to at least a pasteurization temperature of the product. During step S240, the slices are maintained in a tightly stacked face-to-face relationship. That is, the cut faces of the slices contact one another to essentially maintain the shape of the original piece of product.

Step S240 of cooking the animal protein product in a vacuum sealed pouch is a sous-vide process. This sous-vide process differs from known sous-vide processes in that this process is performed on a sliced product and at or above a pasteurization temperature of the product.

In this sous-vide process, cooking is preferably performed in a heated water bath 26 heated to at least the pasteurization temperature of the product, although other ways of heating the sealed product could be used.

In this sous-vide process, the product is cooked while in a sealed pouch, which allows the cellular structure of the product to remain intact. Natural moisture and juices are retained, which improves taste, retains nutritional content, and minimizes shrinkage. Additionally, the product is more fully pasteurized when the pasteurization takes place during this sous-vide process than in a prior art pasteurization process.

Heretofore, known sous-vide processes have only been performed on single pieces of animal protein product, rather than on a sliced product. The inventor was unable to successfully process sliced fish, for example, using this sous-vide process because substances in the slices tended to fuse or coagulate together when cooked in a vacuum sealed state. Surprisingly, however, other animal protein products, such as sliced meat (e.g., beef, pork and lamb) and sliced poultry (e.g., chicken and turkey) were able to be cooked by this sous-vide process without the slices coagulating together. Rather, they are easily separable. Other animal protein products such as sliced game (e.g., venison, snake, duck, and goose) can also be processed via this sous-vide process.

Following the cooking steps in step S240, the product is refrigerated or frozen, while in the pouch 24, in step S250. The refrigerated or frozen product can then be shipped.

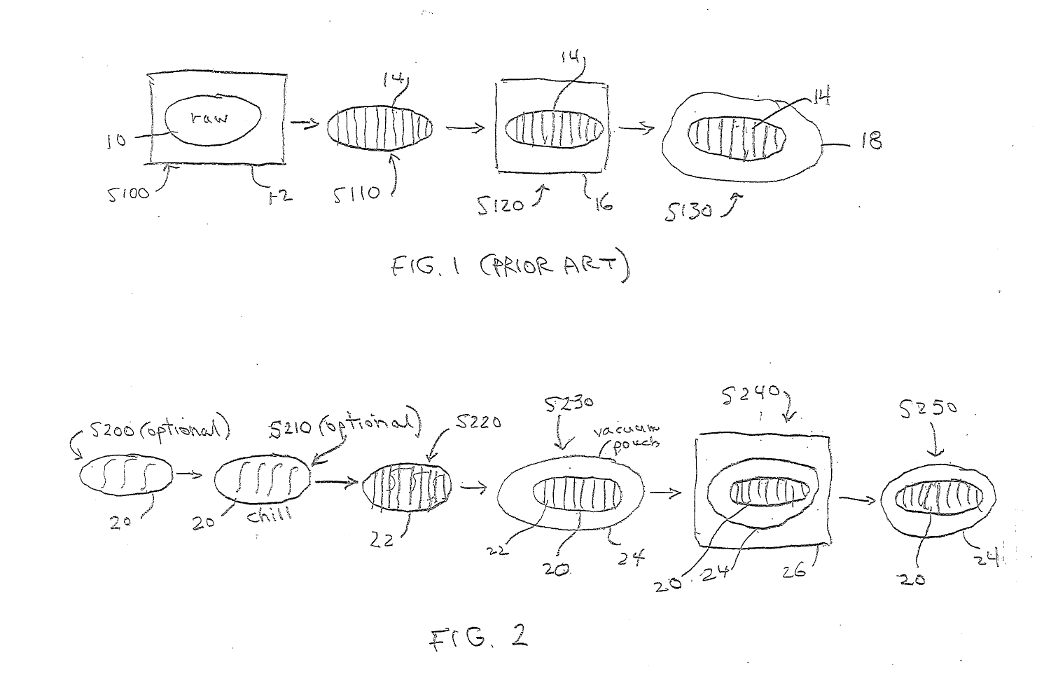

It will be appreciated that the above-described sous-vide process involves only a single cooking step for providing a pre-cooked, sliced animal protein product, thereby reducing cost and energy as compared to the prior art process of FIG. 1.

Although only a preferred embodiment has been described herein, it will also be appreciated that numerous changes substitutions, variations, alterations, transformations, and modifications may be suggested to one skilled in the art, which fall within the spirit and scope of the appended claims.

What is claimed is:

1. A process for processing animal protein product, comprising the steps of:
A. slicing the product into slices while in a substantially raw state;
B. vacuum sealing the sliced raw product within a pouch with the slices stacked tightly together;
C. cooking the vacuum sealed product to at least its pasteurization temperature while vacuum sealed in the pouch; and
D. refrigerating or freezing the cooked product still in the pouch.

2. The process according to claim 1, further including, prior to step A, the step of brazing or searing at least one outside surface of the product.

3. The process according to claim 1, wherein the slices of step A are 1.0-5.0 mm thick.

4. The process according to claim 1, wherein the product is meat.

5. The process according to claim 1, wherein the product is poultry.

6. The process according to claim 1, wherein the product is game.

7. A process for processing meat, poultry or game product, comprising the steps of:
A. brazing or searing at least one outside surface of the product;
B. slicing the brazed or seared product into slices of 1.0-5.0 mm thickness while the product is in a substantially raw state;
C. vacuum sealing the sliced raw product within a pouch with the slices stacked tightly together;
D. cooking the vacuum sealed product to at least its pasteurization temperature while vacuum sealed in the pouch; and
E. refrigerating or freezing the cooked product still in the pouch.
